(19) United States
(12) Patent Application Publication
(10) Pub. No.: US 2006/0196303 A1
(43) Pub. Date: Sep. 7, 2006

(54) Variable radius rotatable handle

(76) Inventors: R. Chad Lowe, Preston, ID (US); Ron Lowe, Franklin, ID (US)

Correspondence Address: Donald W. Meeker, 924 East Ocean Front #E, Newport Beach, CA, 92661, US

(21) Appl. No.: 11/057,463

(22) Filed: Feb. 14, 2005

(51) Int. Cl. G05G 1/10

(52) U.S. Cl. 74/543

(57) ABSTRACT

An arm of a variable radius handle of a screw operated lifting mechanism such as a jack has a pivot hub with a universal opening to fit on existing screw drives. The handle on the arm may be slidably adjustable along the arm or the arm itself may be slidably adjustable relative to the pivot point for variable leverage and turning speed.

### BACKGROUND OF THE INVENTION

1. Field of the Invention

The present invention relates to replacement rotatable handles and particularly to an adjustable radius handle for an existing screw operated lifting mechanism such as a screw operated jack that has a universal mounting hub, the rotatable handle comprising an arm with a handle which adjusts to place the handle at various desired distances from the hub to vary the turning radius for variable leverage and faster and slower turning.

2. Description of the Prior Art

Presently, it is awkward for most people to use the jack handle that comes as a standard part of all vehicles. The jack handle that presently comes with vehicles can be turned a little over 180 degrees, the handle of the jack handle must be brought back toward the person's body, at which time, the jack handle is attached to the jack again and the motion is repeated. A traditional jack handle must be constantly used, detached, reattached, and used again approximately 20-30 times before the jack is at an appropriate level for a user to change a tire or perform other desired car repairs or alterations.

Rotatable screw operated jack handles typically have to turn a large number of times before the jack reaches the necessary height to start lifting the vehicle required large circular arm movements for many turns to bring the jack to the working height. Prior art patents do not adequately address the problem of making it easier and quicker to reach the working height of the jack nor do they provide variable leverage for different turning conditions with no load and a full load on the jack.

U.S. Pat. No. 4,842,252, issued Jun. 27, 1989 to McMahan, describes a three-piece telescoping jack that is capable of rapid coarse adjustments in height. The invention comprises first, second and third elongated tubular members that are somewhat nested in a telescoping relationship. The invention further comprises fine adjustment means for holding and adjusting the position of the second member in relation to the first and coarse adjustment means for holding and adjusting the position of the third member in relation to the second. The coarse adjustment-means further allow the position of the third member to be rapidly adjusted, either retracted or extended, in relation to the second member. In a preferred embodiment, the fine adjustment means are a threaded nut and bolt. Also in a preferred embodiment, the coarse adjustment means are a pin and a series of holes in the second and third members.

U.S. Pat. No. 5,174,550, issued Dec. 29, 1992 to Pittman, discloses a screw jack that incorporates a quick retract mechanism to permit movement of the jack into engagement with the ground such that only limited rotation of the screw is necessary for elevating the tongue of a trailer for disengaging a coupler on the trailer from a trailer hitch. The screw-type jack incorporates an improved handle which is rotatable about a horizontal axis between an active position for rotating the screw about a vehicle axis and a stowed position wherein the handle engages the body of the jack to prevent rotation of the screw. A support for the screw jack incorporates improved versatility so that it can be interchangeably used on other jacks and can be used in applications involving uneven and/or non-level surface conditions.

U.S. Pat. No. 4,316,601, issued Feb. 23, 1982 to Osborne et al., shows a quick-adjusting jackstand apparatus is particularly useful on any harvesting attachments. An improved jackstand has a coarse adjustment and a fine adjustment. Coarse adjustment is accomplished by moving the jackstand from a first stored position to a second extended position. A secondary fine adjustment is accomplished by rotating an inner member which is housed in and threadedly engaged with an outer member. Such rotation results in extension of the inner member from the outer member. The threaded engagement of the members is protected from excessive clogging because such threaded engagement is within the outer member.

U.S. Pat. No. 6,267,357, issued Jul. 31, 2001 to Ebey et al., indicates a drop foot jack, also known as a vehicle landing gear or landing gear jack. A drop foot is telescopically borne within an inner sleeve, which is in turn telescopically borne within an outer sleeve. A rotatable screw is situated within the outer sleeve, and it engages the top surface of the inner sleeve so that rotation of the screw will move the outer sleeve and inner sleeve with respect to each other. The drop foot, inner sleeve, and outer sleeve preferably each have a circumference having multiple discrete sides, e.g., each may have a polygonal cross-section. Apertures are spaced along the lengths of the drop foot and the inner sleeve, and a latch plate having a generally planar configuration which can be selectively moved into aligned apertures in the inner sleeve and the drop foot to thereby engage the drop foot with respect to the inner sleeve. The plane of the latch plate is situated generally perpendicular to the lengthwise axes of the inner sleeve and drop foot, thereby enhancing the surface area of the latch plate that contacts the drop foot and inner sleeve; as a result, the shear strength (and load capacity) of the jack is increased. When the latch plate is inserted in the inner sleeve and drop foot, it engages two or more adjacent sides of the drop foot and the inner sleeve, thereby helping to avoid canting of the drop foot with respect to the inner sleeve. The outer sleeve includes a lubrication passage extending between its exterior and its interior, and the top surface of the inner sleeve has a depressed area adjacent the screw. The lubrication passage allows lubricant injected from the exterior of the outer sleeve to access the depression, whereby lubricant may pool in the depression to maintain the screw in a lubricated state.

U.S. Pat. No. 5,433,127, issued Jul. 18, 1995 to Messier, concerns a multi-functional cylindrically shaped jack handle with a solid first end with a centrally located notched out slot for receipt of flat release screws on hydraulic jacks. The jack handle also has a first shoulder in proximity to the solid first end to prevent insertion of the handle too deeply into the inner compartment of a jack when pumping it up, a hollowed out second end characterized by the presence of two notches located directly across from one another in the perimeter of the hollowed out second end for receipt of ear screws on or within jacks and a second shoulder in close proximity to the hollowed out second end to prevent inadvertent insertion of this end into the well of a jack when pumping it up.

U.S. Pat. No. 1,741,810, issued Dec. 31, 1929 to Bidal, claims a telescopic socket wrench, which allows a user to adjust the length of the wrench arm, thereby bringing the handle closer to the socket end of the wrench.

U.S. Pat. No. 1,510,012, issued Sep. 30, 1924 to Mizer, describes a telescopic handle for a non-rotating detachable automobile jack, which allows for handle length adjustment where available operating space is limited.

What is needed is an adjustable radius rotatable handle that allows a user to turn a screw driven lifting mechanism such as a rotary jack quickly and easily during the phase of elevating the lifting mechanism to the working height and also provide the adequate leverage necessary for turning the screw drive with the full weight of the vehicle or trailer on the lifting mechanism and to properly raise or lower the lifting mechanism without needing to detach the handle from the mechanism.

### SUMMARY OF THE INVENTION

An object of the present invention is to provide a universal mountable adjustable radius handle for a screw operated lifting mechanism such as a rotatable jack, the handle having an arm with a handle that is slidably adjustable to vary the distance of the handle from the pivot point of the arm for variable leverage and adapted for the handle to move in toward the pivot for faster easier turning with little leverage needed during the phase of raising the lifting mechanism up to meet the load and move the adjustable radius handle out away from the pivot point for more leverage during the slower turning phase of lifting the load such as a vehicle or trailer to properly raise or lower the lifting mechanism without needing to detach the adjustable radius handle from the lifting mechanism.

Another object of the present invention is to provide a variable radius screw operated handle which will fit on existing jacks for trailers or vehicles.

In brief, an arm of a variable radius handle for a screw operated lifting device, such as a rotatable drive jack, has a pivot hub with a universal opening to fit on existing screw drives requiring a rotatable handle. The handle on the arm may be slidably adjustable along the arm or the arm itself may be slidably adjustable relative to the pivot point for variable leverage and turning speed. With he adjustable radius handle positioned in close to the pivot, faster and easier turning greatly expedites the raising of the lifting mechanism to meet the load, such as a trailer or vehicle, with little leverage needed during the phase of raising the lifting mechanism up to meet the load. Moving the adjustable radius handle out away from the pivot point provides more leverage during the slower turning phase of lifting the load to properly raise or lower lifting mechanism without needing to detach the adjustable radius handle from the lifting mechanism.

The pivot end of the adjustable radius handle is structured to fit on a universal hub for existing screw operated lifting mechanisms such as rotatable handle screw operated jacks for trailers or vehicles.

The handle protrudes above the arm and may be slidably mounted on the arm by a sleeve encircling the arm with a pin through the sleeve into any of a series of holes along the arm for slidably adjusting the handle and setting it in position for turning the rotatable screw drive. Alternately the arm may slide relative to the pivot point with the arm sliding through a slot in the universal hub of the lifting mechanism and the handle rigidly positioned on the arm. Another sliding handle with a set handle position has a pin protruding from the top of the screw drive and a slot along the length of the handle so that the handle slides relative to the pivot point with the pin in the slot.

An advantage of the present invention is that it provides faster easier turning of the adjustable radius handle with little leverage needed during the phase of raising the lifting mechanism up to meet the load and more leverage during the slower turning phase of lifting the load to properly raise or lower the lifting mechanism without needing to detach the adjustable radius handle from the lifting mechanism.

Another advantage of the present invention is that it provides an adjustable radius handle which will fit on existing universal hubs for screw operated lifting mechanisms such as jacks for trailers or vehicles.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of an adjustable radius rotatable handle with an arm having a handle with a sleeve sliding along the arm;

FIG. 2 is a perspective view of an adjustable radius rotatable handle having a stationary handle on an arm which slides within a slot in a hub mounted on a screw oprated lifting mechanism;

FIG. 3 is a perspective view of an adjustable radius rotatable handle having a stationary handle on an arm with a slot which rides on a vertical pin from the lifting mechanism as the handle slides relative to the lifting mechanism.

### BEST MODE FOR CARRYYING OUT THE INVENTION

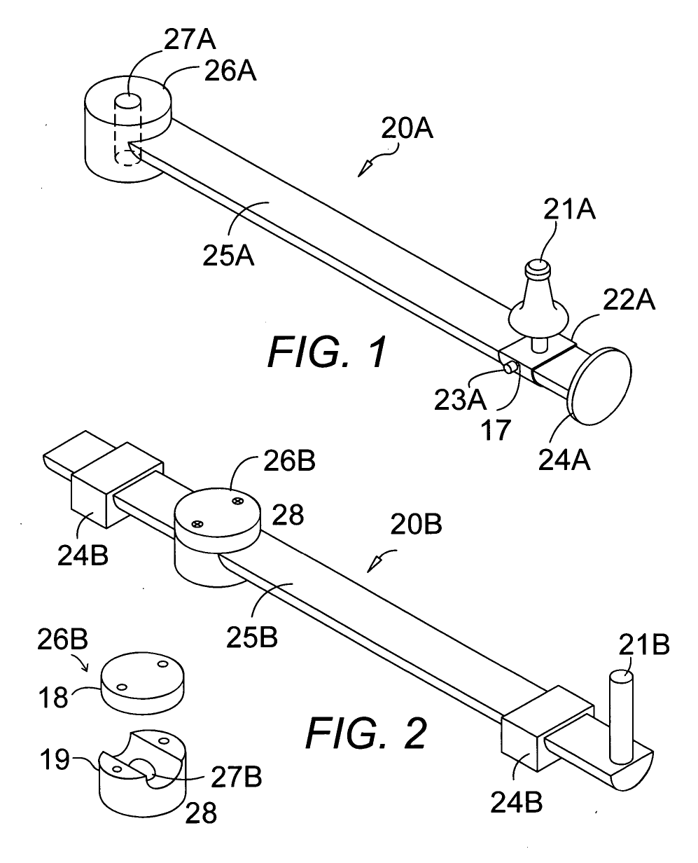

In FIGS. 1-3, a variable radius turning device for operating a rotatably driven screw operated lifting mechanism such as a screw driven jack 30 requiring a rotatable handle for operation, comprises a rigid arm 25A-25C having a universal connector 27A-27C to the rotatable drive of the rotatably driven mechanism forming a pivot point for the arm and a handle 21A-21C which can be positioned at various distances from the pivot point.

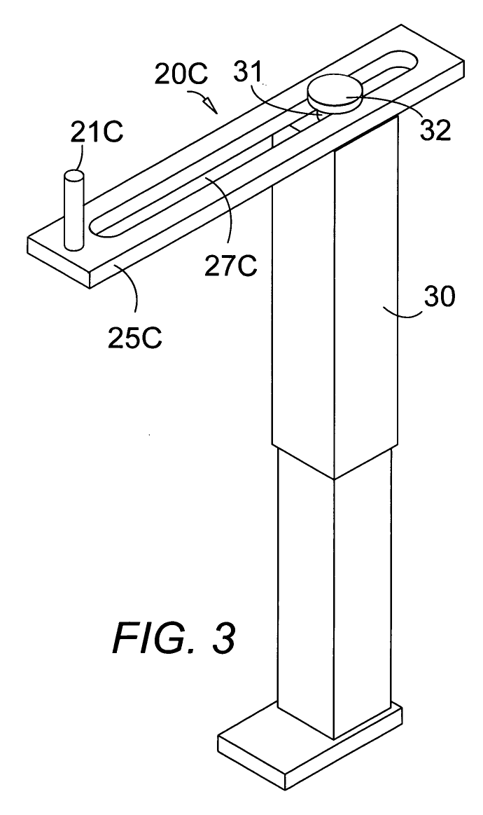

The rigid arm 25A-25C comprises a means of attaching 27A-27B the arm to the rotatable drive of an existing rotatably driven lifting mechanism, such as the rotatable screw jack 30 in FIG. 3. The means of attaching forms a pivot point so that the arm is adapted for pivoting around the pivot point to operate the rotatably driven lifting mechanism such as the jack 30 for elevating and lowering a lifting element of the mechanism or jack. The handle 21A-21C connected to the arm is adapted for being gripped by a user to pivot the arm around the pivot point. The arm and handle are adapted for allowing the handle to move toward the pivot point and away from the pivot point to form an adjustable radius turning device to enable a smaller faster turning radius with the handle positioned close to the pivot point for a faster movement of a lifting element on the rotatable screw operated jack or other rotatably driven mechanism in a no load situation and to enable a larger higher torque radius with the handle positioned away from the pivot point for greater leverage to move a lifting element on the rotatably driven lifting mechanism or rotatable screw operated jack carrying a load. The handle may be secured in a position at a desired radial distance from the pivot point.

In FIG. 1, the means of connecting the handle 21A to the arm 25A comprises a sliding element 22A, in the form of a sleeve attached below the handle 21A which sleeve is adapted for sliding the handle along the arm 25A to change a radial distance of the handle from the pivot point at the universal connector 27A attachable to the rotatable drive. The sleeve 23A may have a threaded or smooth opening 17 therethrough and the means for releasably securing the handle to the arm may comprise a set screw or pin 23A through the opening 17 contacting the arm 25A. The arm may have a series of mating openings (not shown) along its length for the insertion of the pin.

In FIGS. 1 and 2, the means of attaching the arm to a rotatably driven lifting mechanism such as the screw operated jack may comprise a securing element, such as a hub 26A and 26B with an opening 27A and 27B, adapted for fitting over and controlling the top of the rotatable drive such as the screw drive on a standard existing lifting mechanism such as the screw operated jack.

In FIGS. 2 and 3, the handle 21B and 21C is rigidly secured to the arm 25B and 25C respectively, and the arm 25B and 25C slides on the means of attaching the arm to the rotatably driven device. In FIG. 2, the means of attaching the arm to the rotatably driven device, a pivot hub 26B has a slot 28 therethrough and the arm 25B is adapted for sliding in the slot thereby altering the distance between the handle and the pivot point. A stop 24B on each end of the arm 25B limits the sliding. The top 18 of the pivot hub 26B may screw tightly down relative to the bottom 19 of the pivot hub to sandwich the arm 25B releasably securing it therebetween and thereby secure the handle 21B at a desired distance to the pivot point.

In FIG. 3, the means of attaching the arm to the rotatable drive of the rotatably driven mechanism such as the rotatable screw operated jack 30 comprises a vertical pin 31 with two flat sides and a screw cap 32 for releasably securing the arm 25C, protruding from the top of the jack 30 to form the pivot point and the arm 25C has a slot 27C along its length so that the handle 25C slides relative to the jack 30 with the pin 31 in the slot 27C and the arm is adapted for sliding relative to the pin, thereby altering the distance between the handle 21C and the pivot point.

It is understood that the preceding description is given merely by way of illustration and not in limitation of the invention and that various modifications may be made thereto without departing from the spirit of the invention as claimed.

What is claimed is:

1. A variable radius turning device for operating a rotatably driven screw operated lifting mechanism, the device comprising:
a rigid arm comprising a means of attaching the arm to a rotatable drive of a screw operated lifting mechanism, the means of attaching forming a pivot point so that the arm is adapted for pivoting around the pivot point to operate a screw operated lifting mechanism by elevating and lowering a lifting element of the lifting mechanism, and a handle connected to the arm by a means of connecting the handle to the arm, the handle adapted for being gripped by a user to pivot the arm around the pivot point, the arm and handle adapted for allowing the handle to move toward the pivot point and away from the pivot point to form an adjustable radius turning device to enable a smaller faster turning radius with the handle positioned close to the pivot point for a faster movement of a lifting element on a screw operated lifting mechanism in a no load situation and to enable a larger higher torque radius with the handle positioned away from the pivot point for greater leverage to move a lifting element on a screw operated lifting mechanism carrying a load, and a means for releasably securing the handle at a desired radial distance from the pivot point.

2. The device of claim 1 wherein the means of connecting the handle to the arm comprises a sliding element adapted for sliding the handle along the arm to change a radial distance of the handle from the pivot point.

3. The device of claim 2 wherein the sliding element comprises a sleeve secured below the handle, the sleeve adapted for encircling the arm and sliding along the arm.

4. The device of claim 3 wherein the sleeve has a threaded opening therethrough and the means for releasably securing the handle to the arm comprises a set screw through the threaded opening.

5. The device of claim 3 wherein the sleeve has an opening therethrough and the arm has a series of openings along its length and the means for releasably securing the handle to the arm comprises a pin through the sleeve opening and one of the arm openings.

6. The device of claim 1 wherein the means of attaching the arm to a screw operated lifting mechanism comprises a securing element adapted for fitting on a means for controlling rotation on an existing screw operated lifting mechanism.

7. The device of claim 1 wherein the handle is rigidly secured to the arm and the means of attaching the arm to a screw operated lifting mechanism has a slot therethrough and the arm is adapted for sliding in the slot thereby altering a distance between the handle and the pivot point.

8. The device of claim 1 wherein the handle is rigidly secured to the arm and the means of attaching the arm to a screw operated lifting mechanism comprises a vertical pin protruding from the top of a screw operated lifting mechanism at the pivot point and the arm has a slot along its length so that the handle slides relative to the pivot point with the pin in the slot and the arm is adapted for sliding relative to the pin, thereby altering a distance between the handle and the pivot point.

9. The device of claim 1 wherein the screw operated lifting mechanism comprises a rotatable drive screw operated jack.
